(19) United States
(12) Patent Application Publication
(10) Pub. No.: US 2026/0001413 A1
(43) Pub. Date: Jan. 1, 2026

(54) ELECTRIFIED VEHICLE AND METHOD OF CONTROLLING SAME

(71) Applicants: HYUNDAI MOTOR COMPANY, SEOUL (KR); KIA CORPORATION, SEOUL (KR)

(72) Inventors: Ho Sun JANG, Hwaseong-si (KR); Jang Yoon JEONG, Hwaseong-si (KR); Jin Wook KANG, Hwaseong-si (KR)

(21) Appl. No.: 18/954,786

(22) Filed: Nov. 21, 2024

(30) Foreign Application Priority Data
Jul. 1, 2024 (KR) 10-2024-0086250

(51) Int. Cl. B60L 50/60; B60R 16/023; H02M 1/14; H02M 7/5387

(52) U.S. Cl. CPC B60L 50/60; B60R 16/0231; H02M 1/14; H02M 7/5387; B60L 2210/40; B60L 2240/423; B60L 2240/429; B60L 2240/527; B60L 2260/26

(57) ABSTRACT

An electrified vehicle includes a motor having a plurality of windings, a first inverter, a main battery, and a controller configured to perform linearization control on a voltage modulation index, so as to limit a change rate of the voltage modulation index during switching between a first driving mode and a second driving mode while an auxiliary battery is mounted.

### CROSS REFERENCE TO RELATED APPLICATION

The present application claims priority to Korean Patent Application No. 10-2024-0086250, filed Jul. 1, 2024, the entire contents of which are incorporated herein for all purposes by this reference.

### BACKGROUND

### Field

The present disclosure relates to an electrified vehicle, which is capable of mounting an auxiliary battery in addition to a main battery, and a method of controlling the same.

### Description of Related Art

Recently, in accordance with the global trend of reducing carbon dioxide emissions, there is a significantly increasing demand for electrified vehicles that generate driving power by driving a motor with electrical energy stored in a battery, instead of typical internal combustion engine vehicles that generate driving power through combustion of fossil fuels.

In a case of an electrified vehicle, the time required to charge a battery is relatively longer than a refueling time of an internal combustion engine vehicle in comparison, so the maximum driving distance that may be driven with one full charge of the battery is important.

The maximum driving distance of each electrified vehicle may vary depending on the voltage and capacity of a battery therein. Even though each battery has the same capacity, the voltage and the amount of charge may vary depending on combination of series/parallel connection between modules or cells of each battery. For example, the voltage of the battery may correspond to a value obtained by multiplying the voltage of a battery cell by the number of cells connected in series, and the amount of charge of the battery may correspond to a value obtained by multiplying the amount of charge of a battery cell by the number of cells connected in parallel.

Accordingly, a solution to increase a battery voltage may be considered to increase a driving distance, but in order for the battery voltage to increase, it is required to strengthen a withstand voltage design of a motor system as well, so a solution capable of increasing the driving distance without increasing the battery voltage is required to be proposed.

The foregoing is intended merely to aid in the understanding of the background of the present disclosure, and is not intended to mean that the present disclosure falls within the purview of the related art that is already known to those skilled in the art.

### SUMMARY

An objective of the present disclosure is to resolve a technical task for efficiently increasing a driving distance of an electrified vehicle through an auxiliary battery mounted separately from a main battery and alleviating torque fluctuations that may occur when the auxiliary battery is connected or disconnected to a motor of the electrified vehicle.

The technical problems to be solved in the present disclosure are not limited to the technical problems mentioned above, and other technical problems that are not mentioned will be clearly understood by those skilled in the art to which the present disclosure belongs from the following description.

According to exemplary embodiments of the present disclosure, there is provided an electrified vehicle capable of mounting an auxiliary battery, the electrified vehicle including a motor having a plurality of windings, a first inverter having direct current (DC) terminals and including a plurality of legs connected to respective first ends of the plurality of windings, a main battery connected to the DC terminals, and a controller configured to perform linearization control on a voltage modulation index so as to limit a change rate of the voltage modulation index serving as a basis for an electric current command for the motor during switching between a first driving mode for driving the motor in a state where the auxiliary battery and the motor are electrically disconnected from each other while the auxiliary battery is mounted and a second driving mode for driving the motor in a state where the auxiliary battery is electrically located between and connected to one end of the DC terminals and respective second ends of the plurality of windings.

According to the exemplary embodiments of the present disclosure, there is provided a method of controlling an electrified vehicle including a motor having a plurality of windings, a first inverter having DC terminals and including a plurality of legs connected to respective first ends of the plurality of windings, and a main battery connected to the DC terminals, the electrified vehicle being capable of mounting an auxiliary battery, and the method including generating an electric current command for the motor on the basis of a voltage modulation index, and performing linearization control on the voltage modulation index so as to limit a change rate of the voltage modulation index during switching between a first driving mode for driving the motor in a state where the auxiliary battery and the motor are electrically disconnected from each other while the auxiliary battery is mounted and a second driving mode for driving the motor in a state where the auxiliary battery is electrically located between and connected to the DC terminals to which the main battery is connected and the plurality of windings.

According to various exemplary embodiments of the present disclosure as described above, an auxiliary battery may be used together with a main battery to drive a motor, thereby efficiently increasing a driving distance of an electrified vehicle.

In addition, through linearization control of a voltage modulation index, torque fluctuations that may occur when an auxiliary battery is connected or disconnected to a motor may be alleviated.

The effects of the present disclosure are not limited to the above-mentioned effects, and other effects that are not mentioned herein will be clearly understood by those skilled in the art from the following description.

### BRIEF DESCRIPTION OF THE DRAWINGS

FIG. 1 is a view illustrating a configuration of an electrified vehicle according to exemplary embodiments of the present disclosure.

FIGS. 2 and 3 are views illustrating respective examples of implementing motor systems applicable to the exemplary embodiments of the present disclosure.

FIG. 4 is a view illustrating a first driving mode and a second driving mode according to the exemplary embodiments of the present disclosure.

FIG. 5 is a view illustrating a voltage modulation index for each mode according to the exemplary embodiments of the present disclosure.

FIG. 6 is a view illustrating a detailed configuration of a controller according to the exemplary embodiments of the present disclosure.

FIGS. 7 and 8 are views illustrating linearization control according to the exemplary embodiments of the present disclosure.

FIG. 9 is a flowchart illustrating a method of controlling an electrified vehicle according to the exemplary embodiments of the present disclosure.

### DETAILED DESCRIPTION

Specific structural and functional descriptions of the embodiments of the present disclosure disclosed herein are only for illustrative purposes of the embodiments of the present disclosure. The present disclosure may be embodied in many different forms. Therefore, the embodiments of the present disclosure should not be construed as limiting the present disclosure.

Since the exemplary embodiments of the present disclosure may be variously modified in many different forms, specific exemplary embodiments will be illustrated in the drawings and described in detail in the specification or application of the present disclosure. However, this is not intended to limit the exemplary embodiments in accordance with the concept of the present disclosure to a particular disclosed form. On the contrary, the present disclosure is to be understood to include all various alternatives, equivalents, and substitutes that may be included within the spirit and technical scope of the present disclosure.

Unless otherwise defined, all terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the related art, and will not be interpreted in an idealized or overly formal sense unless expressly so defined herein.

Hereinafter, exemplary embodiments disclosed in the present specification will be described in detail with reference to the accompanying drawings, but regardless of the reference numerals, the same or similar components are given the same reference numbers, and the overlapping description thereof will be omitted.

In the description of the following exemplary embodiments, the term “preset” means that a value of a parameter is predetermined when the parameter is used in a process or algorithm. Depending on the exemplary embodiments, a numerical value of the parameter may be set when the process or algorithm starts execution or may be set during a section in which the process or algorithm is performed.

The “module” and “part/unit” for naming compound noun-type components used in the following descriptions are given or mixed in consideration of only the ease of writing the specification, and the suffixes do not have distinct meanings or roles by themselves.

In describing the exemplary embodiments disclosed in the present specification, when it is determined that a detailed description of a related known technology may obscure the subject matter of the exemplary embodiments disclosed in the present specification, the detailed description thereof will be omitted. In addition, the accompanying drawings are only for easy understanding of the exemplary embodiments disclosed in the present specification, the technical idea disclosed in the present specification is not limited by the accompanying drawings, and it should be understood that the accompanying drawings include all changes, equivalents, or substitutes, which are included in the spirit and technical scope of the present disclosure.

It will be understood that, although the terms including ordinal numbers, such as first, second, etc. may be used herein to describe various components, these components should not be limited by these terms. These terms are only used for the purpose of distinguishing one component from another component.

When a component is described as being “connected”, “coupled”, or “linked” to another component, that component may be directly connected, coupled, or linked to that other component. However, it should be understood that yet another component between each of the components may be present. In contrast, when a component is described as being “directly connected”, “directly coupled”, or “directly linked” to another component, it should be understood that there are no intervening component present therebetween.

As used herein, the singular forms are intended to include the plural forms as well, unless the context clearly indicates otherwise.

It will be further understood that the terms “comprise”, “include”, “have”, etc. when used in the present specification, specify the presence of stated features, integers, steps, operations, elements, components, and/or combinations of them but do not preclude the presence or addition of one or more other features, integers, steps, operations, elements, components, and/or combinations thereof.

In addition, a unit or control unit included in names such as a motor control unit (MCU) and a hybrid control unit (HCU) is just a term widely used for naming of a control unit that controls vehicle-specific functions, and does not mean a generic function unit.

The control unit may include a communication device for communicating with other controllers or sensors in order to control functions in charge, a memory for storing an operating system, logic instructions, and input/output information, and one or more processors for performing determinations, calculations, decisions, etc., which are required for controlling the functions in charge.

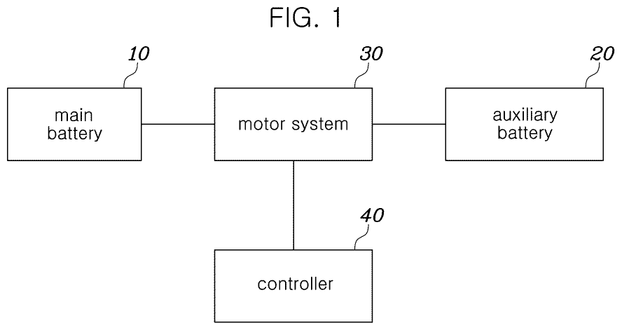

Hereinafter, a configuration of an electrified vehicle according to exemplary embodiments of the present disclosure will first be described with reference to FIGS. 1 to 8.

FIG. 1 is a view illustrating a configuration of an electrified vehicle according to the exemplary embodiments of the present disclosure.

Referring to FIG. 1, the electrified vehicle according to the exemplary embodiments includes a main battery 10, a motor system 30, and a controller 40, and may include an auxiliary battery 20 mounted therein. Hereinafter, the description will be made on an assumption that the auxiliary battery 20 is mounted on the electrified vehicle according to the exemplary embodiments.

The motor system 30 may include: a motor that is a power source of the electrified vehicle; and at least one inverter for driving the motor, and may be located between the main battery 10 and the auxiliary battery 20 and connected to both.

More specifically, the motor system 30 may drive the motor through the operation of the inverter based on the voltage of the main battery 10.

In addition, in the electrified vehicle according to the exemplary embodiments, the auxiliary battery 20 may be selectively connected to the motor system 30, and when the auxiliary battery 20 is connected to the motor system 30, the auxiliary battery 20 may supply power to the motor system 30. In the exemplary embodiments of the present disclosure, the auxiliary battery 20 is distinguished from the main battery 10, and for example, the capacity or voltage of the auxiliary battery 20 is less than or equal to the capacity or voltage of the main battery 10. In addition, the auxiliary battery 20 is distinguished from a low-voltage (e.g., 12 V) battery for operating electronic components in that the auxiliary battery 20 may be used to drive the motor 31, and the auxiliary battery 20 may have a larger capacity or higher voltage than that of the low-voltage battery that operates the electronic components.

In this case, the auxiliary battery 20 may be used as a power source for driving the motor, or may be used to charge the main battery 10 by supplying power to the main battery 10 through the motor system 30. In addition, the auxiliary battery 20 may also be charged by receiving power from the main battery 10 through the motor system 30.

Meanwhile, the controller 40 may control a switching state and the like of the inverter included in the motor system 30. In addition, the controller 40 may control the motor system 30 according to a first driving mode in which the auxiliary battery 20 and the motor of the motor system 30 are electrically disconnected from each other or a second driving mode in which the auxiliary battery 20 and the motor of the motor system 30 are electrically connected to each other, and in this case, an electric current command for the motor of the motor system 30 may be generated on the basis of a voltage modulation index.

In implementation, the controller 40 may be implemented as a single controller, or may also be implemented in a form in which functions thereof are distributed among a plurality of controllers. For example, the controller 40 may be implemented by combining both of a motor control unit (MCU) configured to control the motor of the motor system 30 and an upper level controller thereof (e.g., a hybrid control unit (HCU), an integrated vehicle control unit (VCU), a hydrogen fuel cell control unit (FCCU), etc.), but is not necessarily limited thereto. According to another implementation, a controller 40 may also further include a charge controller.

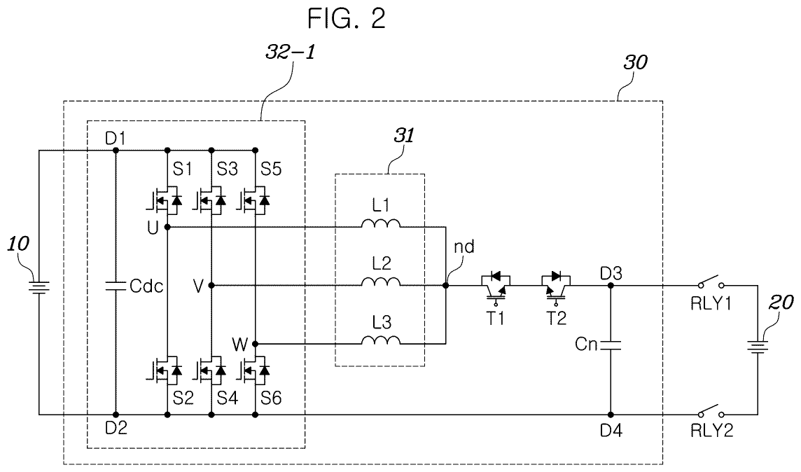

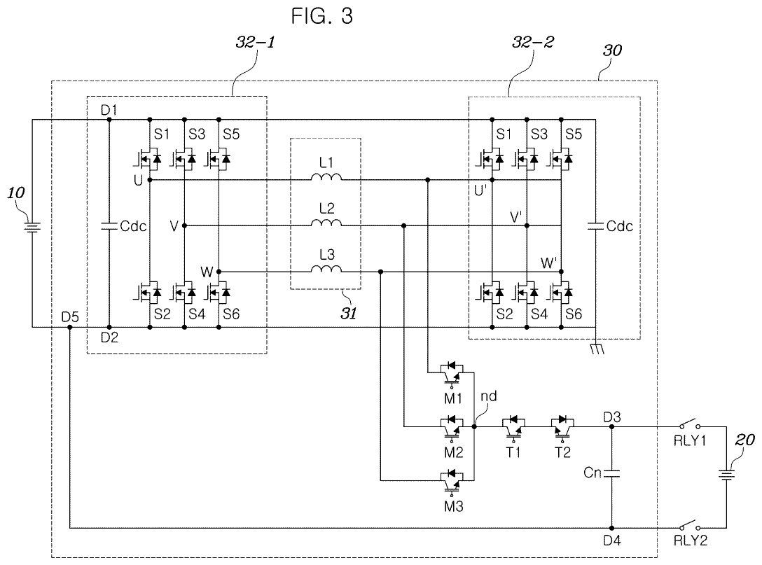

As described above, the motor system 30 may be electrically connected not only to the main battery 10 but also to the auxiliary battery 20, and in this case, may increase a driving distance by using the power of the auxiliary battery 20 to drive the motor. Structures therefore are illustrated in FIGS. 2 and 3.

FIGS. 2 and 3 are views illustrating respective examples of implementing motor systems applicable to the exemplary embodiments of the present disclosure.

More specifically, FIG. 2 shows an example in which a motor system 30 is implemented in a structure of a single inverter 32-1, and FIG. 3 shows an example in which a motor system 30 is implemented in a structure of dual inverters 32-1 and 32-2.

First, referring to FIG. 2, the motor system 30 according to the exemplary embodiments may include a motor 31, a first inverter 32-1, charging switches T1 and T2, and direct current capacitors Cdc and Cn. In addition, the motor system 30 may have DC terminals D1, D2, D3, and D4 connected to a main battery 10 and an auxiliary battery 20.

More specifically, the motor 31 may include a plurality of windings L1, L2, and L3 respectively corresponding to a plurality of phases U, V, and W. The first inverter 32-1 has the DC terminals D1 and D2 connected to the main battery 10, and may include a plurality of legs S1-S2, S3-S4, and S5-S6 connected to respective first ends of the plurality of windings L1, L2, and L3 included in the motor 31.

The charging switches T1 and T2 may be located between and connected to the auxiliary battery 20 and second ends of the plurality of windings L1, L2, and L3 included in the motor 31. More specifically, the charging switches T1 and T2 may be located between and connected to a positive pole of the auxiliary battery 20 and a node nd in which the plurality of windings L1, L2, and L3 is interconnected together so as to form a neutral point of the motor 31. In the exemplary embodiments, the charging switches T1 and T2 may be implemented with an Insulated Gate Bipolar Transistor (IGBT), but may also be implemented with other elements such as a Metal Oxide Semiconductor Field Effect Transistor (MOSFET) capable of performing a switching operation, depending on the exemplary embodiments. Although the charging switches T1 and T2 are connected to each other in series in FIGS. 2 and 3, the connection structure thereof is not necessarily limited thereto.

The first driving mode or second driving mode described above may be performed depending on the turn-on/off states of such charging switches T1 and T2. More specifically, in the first driving mode, the charging switches T1 and T2 are turned off, in which case the node nd and the auxiliary battery 20 are electrically separated from each other, so that the auxiliary battery 20 is disconnected from the motor 31. In contrast, in the second driving mode, the charging switches T1 and T2 are turned on, in which case the node nd and the auxiliary battery 20 are electrically connected to each other, so that the auxiliary battery 20 and the motor 31 are connected to each other.

Meanwhile, the motor system 30 may be connected to the auxiliary battery 20 through relays RLY1 and RLY2. In this case, the relay RLY1 may be located between and connected to a DC terminal D3 and a positive pole of the auxiliary battery 20, and the relay RLY2 may be located between and connected to a DC terminal D4 and a negative pole of the auxiliary battery 20.

In the exemplary embodiments, the term “a state in which an auxiliary battery 20 is mounted” may mean a case where the relays RLY1 and RLY2 are turned on and the auxiliary battery 20 is connected to the motor system 30. However, even when the relays RLY1 and RLY2 are turned on and the auxiliary battery 20 is mounted, the auxiliary battery 20 may be electrically connected to or disconnected from the motor 31 depending on the turn-on/off state of the charging switches T1 and T2.

More specifically, the positive pole of the auxiliary battery 20 is connected to the node nd formed at the respective second ends of the plurality of windings L1, L2, and L3 through the charging switches T1 and T2 and the relays RLY1 and RLY2, and the negative pole of the auxiliary battery 20 may be selectively connected to the DC terminal D4.

Meanwhile, as shown in FIG. 1, a separate relay may not be provided between the main battery 10 and the motor system 30, but depending on the exemplary embodiments, a relay may be provided between the main battery 10 and the motor system 30 as well.

The direct current capacitors Cdc and Cn may be provided to alleviate electric current ripples. More specifically, the DC capacitor Cdc located between and connected to the DC terminal D1 and the DC terminal D2 may alleviate ripples on the current of the main battery 10, and the DC capacitor Cn located between and connected to the DC terminal D3 and the DC terminal D4 may alleviate ripples on the current of the auxiliary battery 20.

Hereinafter, the motor system 30 illustrated in FIG. 3 will be described with a focus on differences from the motor system 30 illustrated in FIG. 2.

Referring to FIG. 3, in the exemplary embodiments, the motor system 30 according to the exemplary embodiments may further include a second inverter 32-2 and a plurality of switching switches M1, M2, and M3 in comparison with those in FIG. 2.

The second inverter 32-2 may include a plurality of legs S1′-S2′, S3′-S4′, and S5′-S6′ connected to the respective second ends of the plurality of windings L1, L2, and L3.

The plurality of switching switches M1, M2, and M3 may have respective first ends thereof connected to the second ends of the plurality of windings L1, L2, and L3, and may have respective second ends thereof interconnected together so as to form a node nd. Such a plurality of switching switches M1, M2, and M3 may determine detailed driving modes through the first inverter 32-1 and the second inverter 32-2 in a first driving mode.

More specifically, the first driving mode may include a Closed End Winding (CEW) mode and an Open End Winding (OEW) mode. First, in the CEW mode, the plurality of switching switches M1, M2, and M3 are turned on. In this case, the node nd becomes the neutral point of the motor 31, and the motor 31 is driven only through the first inverter 32-1. Such a CEW mode may be performed for efficient driving of the motor 31 in a low power output section.

In contrast, in the OEW mode of the first driving mode, the plurality of switching switches M1, M2, and M3 are turned off. In this case, the node nd does not become the neutral point of the motor 31, and the second inverter 32-2 together with the first inverter 32-1 may be enabled to drive the motor 31. Such an OEW mode may be performed to increase the driving power of the motor 31 in a high power output section.

Meanwhile, in such a structure of the dual inverters 32-1 and 32-2, the auxiliary battery 20 may be located between and connected to a DC terminal D5 and the respective second ends of the plurality of windings L1, L2, and L3. More specifically, through the charging switches T1 and T2 and the relays RLY1 and RLY2, the positive pole of the auxiliary battery 20 may be connected to the node nd formed at second ends of the plurality of switching switches M1, M2, and M3, and the negative pole of the auxiliary battery 20 may be connected to the DC terminal D5.

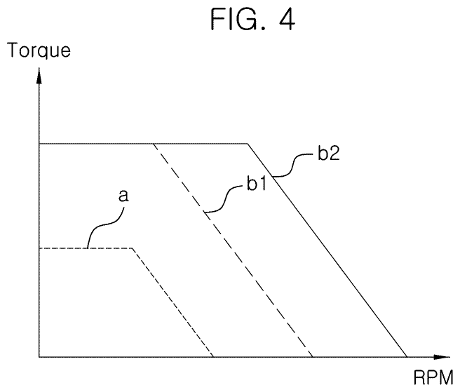

Hereinafter, the operation areas of a first driving mode and a second driving mode will be briefly described with reference to FIG. 4.

FIG. 4 is a view illustrating the first driving mode and the second driving mode according to the exemplary embodiments of the present disclosure.

Referring to FIG. 4, the operation areas of the first driving mode and second driving mode may be expressed as a graph for the rotation speed and torque of the motor 31.

First, CEW mode b1 is performed in a low power output section where rotation speed and torque are relatively low compared to those of OEW mode b2. In contrast, the OEW mode b2 may be performed in a high power output section where rotation speed and torque are relatively high compared to those of the CEW mode b1.

The second driving mode “a” may be performed within an operation area of the CEW mode b1, and may be performed in the lowest output area where the rotation speed and torque are relatively the lowest. By utilizing the auxiliary battery 20 together with the main battery 10 to drive the motor 31 in the lowest output area, a driving distance may be increased.

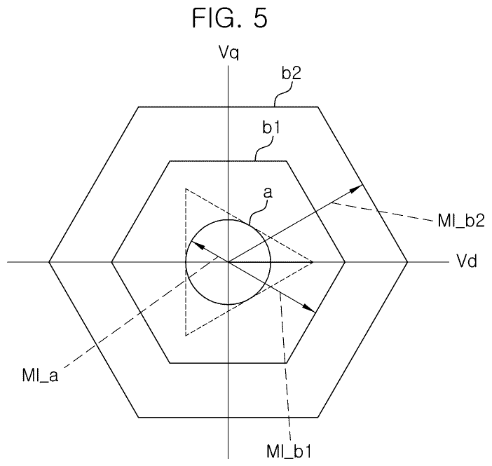

Meanwhile, the first driving mode (i.e., the CEW mode and the OEW mode) and the second driving mode have different voltage limit areas allowing operation for each mode to be performed, and this will be described below with reference to FIG. 5.

FIG. 5 is a view illustrating a voltage modulation index for each mode according to the exemplary embodiments of the present disclosure.

Referring to FIG. 5, the voltage limit areas of the second driving mode a, CEW mode b1, and OEW mode b2 are illustrated as respective voltage vectors in the view represented by Direct axis (D-axis) voltages Vd and Quadrature axis (Q-axis) voltages Vq.

OEW mode b2 may have a larger voltage vector than that of CEW mode b1. Accordingly, the maximum value of a voltage modulation index MI_b2 available in the OEW mode b2 becomes higher than the maximum value of a voltage modulation index MI_b1 available in the CEW mode b1.

In addition, the second driving mode “a” may have a smaller voltage vector compared to that of the CEW mode b1. Accordingly, the maximum value MI_a of a voltage modulation index available in the second driving mode “a” has a lower value than the maximum value MI_b of the voltage modulation index available in the CEW mode b1.

Due to differences in the voltage limit area and voltage modulation index as described above, a change in the voltage limit area may occur during switching between each mode, and thus, torque fluctuations may occur. Accordingly, the present application proposes a method for improving driving experience by alleviating the torque fluctuations during mode switching.

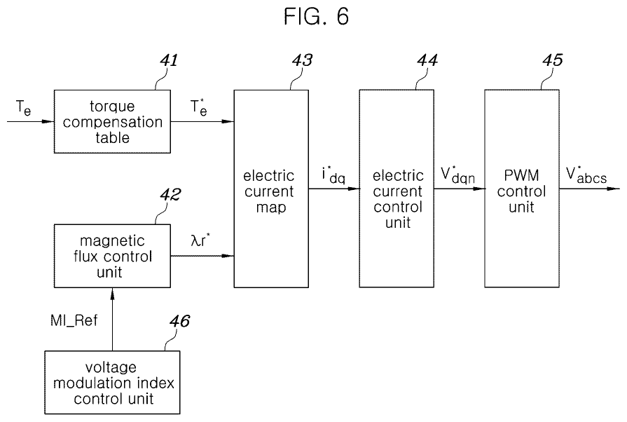

Accordingly, the electrified vehicle and the method of controlling the same according to the exemplary embodiments of the present disclosure proposes a method of increasing a driving distance of an electrified vehicle by providing an auxiliary battery together with a main battery and performing linearization control on a voltage modulation index when discharge of the auxiliary battery starts or stops, so that torque fluctuations are alleviated. Hereinafter, a configuration of a controller for performing such linearization control described above will be described in detail with reference to FIGS. 6 to 8.

FIG. 6 is a view illustrating a detailed configuration of a controller according to the exemplary embodiments of the present disclosure.

Referring to FIG. 6, the controller 40 may include a torque compensation table 41, a magnetic flux control unit 42, an electric current map 43, an electric current control unit 44, a PWM control unit 45, and a voltage modulation index control unit 46.

First, the torque compensation table 41 may receive input of output torque Te of a motor and generate a corresponding torque command Te* by reflecting a torque error, etc. The magnetic flux control unit 42 may receive a control value MI_Ref of a voltage modulation index and generate a magnetic flux command λr* based thereon. The electric current map 43 may receive the torque command Te* and the control value MI_Ref of the voltage modulation index from the torque compensation table 41 and the magnetic flux control unit 42 and generate a corresponding electric current command idq*. Here, the control value MI_Ref of the voltage modulation index corresponds to a control target of the voltage modulation index of an inverter, and the electric current command idq* may include a D-axis electric current command and a Q-axis current command.

The electric current control unit 44 may generate a D-axis and Q axis voltage command Vdqn* on the basis of the D-axis and Q-axis electric current command idq* generated through the electric current map 43, and the PWM control unit 45 may receive the D-axis and Q-axis voltage command Vdqn* and output a phase voltage command Vabcs* for AC terminals of the inverter through pulse width modulation control. As a result of such pulse width modulation control, a phase voltage corresponding to the phase voltage command Vabcs* is generated in each phase AC terminal of the inverter.

Meanwhile, the voltage modulation index control unit 46 may determine the control value MI_Ref of the voltage modulation index, the control value MI_Ref becoming an input value of the magnetic flux control unit 42. In addition, the voltage modulation index control unit 46 may perform linearization control on the voltage modulation index, so as to limit a fluctuation range of the voltage modulation index during switching between the first driving mode and the second driving mode.

More specifically, in a case of starting switching between the first driving mode and the second driving mode, the voltage modulation index control unit 46 may perform linearization control by adding or subtracting a preset correction value to or from the voltage modulation index according to the mode before the switching. In this case, the correction value may be set to have a value smaller than a difference between the maximum value of the voltage modulation index available in the first driving mode and the maximum value of the voltage modulation index available in the second driving mode, which are as described with reference to FIG. 5.

The voltage modulation index control unit 46 may repeat the adding or subtracting of the correction value until the voltage modulation index according to the mode before the switching reaches a voltage modulation index according to the mode after the switching, thereby allowing the voltage modulation index to fluctuate linearly without an abrupt change.

That is, the linearization control is performed so that a change rate (i.e., an amount of change per unit time) of a voltage modulation index is limited during mode switching, and accordingly, the change rate of the voltage modulation index at each time point is limited within a correction value, whereby torque fluctuations due to fluctuations of the voltage modulation index during the mode switching may be alleviated.

Afterwards, when the voltage modulation index according to the mode before the switching reaches the voltage modulation index according to the mode after the switching, the voltage modulation index control unit 46 may determine the present voltage modulation index as a control value MI_Ref of the voltage modulation index. In this case, the control value MI_Ref of the determined voltage modulation index is utilized by the magnetic flux control unit to generate a magnetic flux command λr*, and an electric current command idq* is generated on the basis of the magnetic flux command λr*, whereby as a result, the electric current command idq* is generated on the basis of the control value MI_Ref of the voltage modulation index.

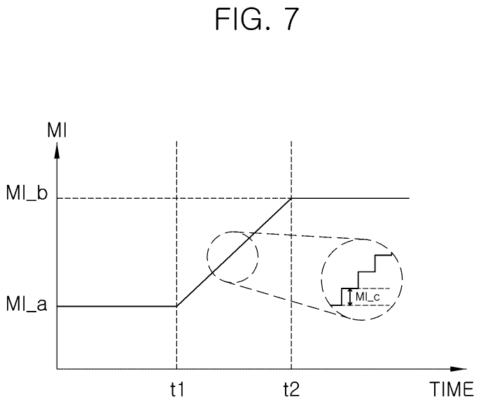

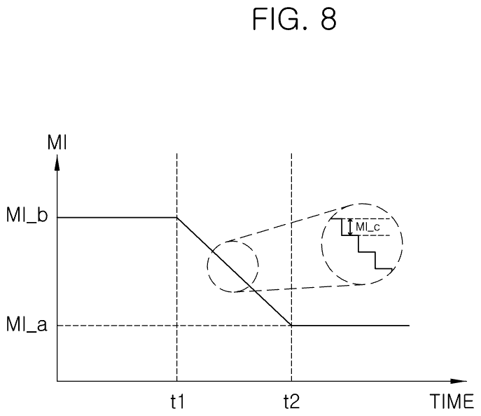

Meanwhile, linearization control may be performed in different ways during switching from the second driving mode to the first driving mode and during switching from the first driving mode to the second driving mode. This will be described with reference to FIGS. 7 and 8.

FIGS. 7 and 8 are views illustrating linearization control according to the exemplary embodiments of the present disclosure.

First, referring to FIG. 7, a process of linearization control performed during switching from a second driving mode to a first driving mode is illustrated as a graph of time and voltage modulation index.

On the time axis of the graph, a section up to a time point t1 is a section in which the second driving mode with a relatively low voltage modulation index is performed, a section from the time point t1 to a time point t2 is a section in which linearization control is performed according to mode switching, and a section after the time point t2 is a section in which the first driving mode is performed according to the mode switching.

At the time point t1 of starting the mode switching from the second driving mode to the first driving mode, the voltage modulation index control unit 46 starts adding a correction value MI_c to the present voltage modulation index MI_a according to the second driving mode, and such addition is repeatedly performed until the time point t2 at which the voltage modulation index gradually increases by the correction value MI_c and reaches a voltage modulation index MI_b according to the first driving mode.

Next, referring to FIG. 8, a process of linearization control performed during switching from a first driving mode to a second driving mode is illustrated as a graph of time and voltage modulation index.

On the time axis of the graph, a section up to a time point t1 is a section in which the first driving mode with a relatively high voltage modulation index is performed, a section from the time point t1 to a time point t2 is a section in which linearization control is performed according to mode switching, and a section after the time point t2 is a section in which the second driving mode is performed according to the mode switching.

At the time point t1 of starting the mode switching from the first driving mode to the second driving mode, the voltage modulation index control unit 46 starts to subtract a correction value MI_c from the present voltage modulation index MI_b according to the first driving mode, and such subtraction is repeatedly performed until the time point t2 at which the voltage modulation index gradually decreases by the correction value MI_c and reaches a voltage modulation index MI_a according to the second driving mode.

Hereinafter, a method of controlling the electrified vehicle described so far will be described with reference to a flowchart.

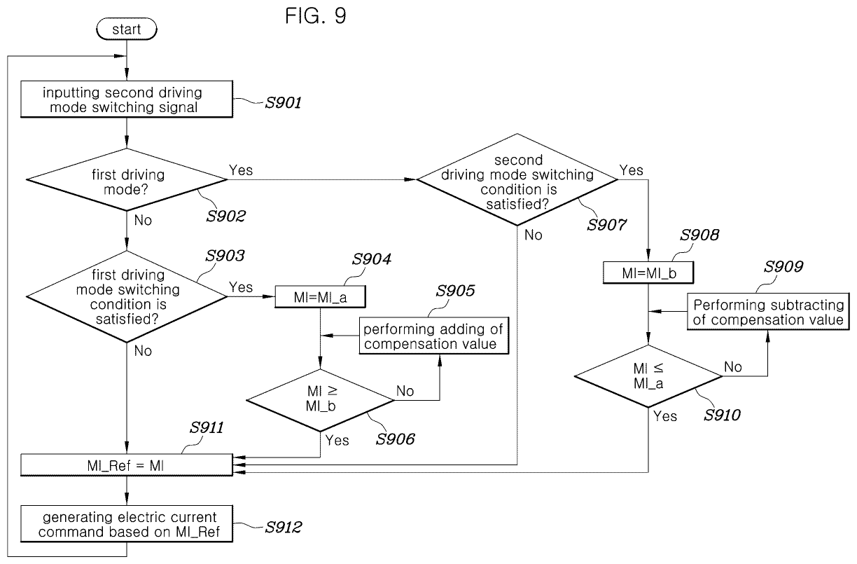

FIG. 9 is a flowchart illustrating a method of controlling an electrified vehicle according to the exemplary embodiments of the present disclosure.

Referring to FIG. 9, when a second driving mode switching signal is input in step S901, a controller 40 may not perform linearization control in a case where a current mode is not a first driving mode (i.e., “No” of step S902) and also a switching condition of the first driving mode is not satisfied (i.e., “No” of step S903), that is, in a case where mode switching is not required. In this case, the controller 40 determines the present voltage modulation index MI as a control value MI_Ref of the voltage modulation index in step S911, and then generates an electric current command on the basis thereon in step S912.

In contrast, when a second driving mode switching signal is input in S901, the controller 40 performs linearization control in a case where a current mode is not the first driving mode (i.e., “No” of step S902) and also a switching condition of the first driving mode is satisfied (i.e., “Yes” of step S903), that is, in a case where mode switching from the second driving mode to the first driving mode is performed. In this case, a voltage modulation index MI at the time point of starting the mode switching corresponds to a voltage modulation index MI_a of the second driving mode in step S904, and the controller 40 adds a compensation value to the voltage modulation index MI in step S905 until the voltage modulation index MI increases and reaches a voltage modulation index MI_b of the first driving mode (i.e., “Yes” of step S906). When the voltage modulation index MI reaches the voltage modulation index MI_b of the first driving mode (i.e., “Yes” in step S906), the controller 40 determines the present voltage modulation index MI as a control value MI_Ref of the voltage modulation index in step S911, and then generates an electric current command on the basis thereon in step S912.

Meanwhile, when a second driving mode switching signal is input in step S901, the controller 40 may not perform linearization control in a case where the current mode is the first driving mode (i.e., “Yes” of step S902) and the switching condition of the second driving mode is not satisfied (i.e., “No” of step S907), that is, in a case where mode switching is not available. In this case, the controller 40 determines the present voltage modulation index MI as a control value MI_Ref of the voltage modulation index in step S911, and then generates an electric current command on the basis thereon in step S912.

In contrast, when a second driving mode switching signal is input in step S901, the controller 40 performs linearization control in a case where the current mode is the first driving mode (i.e., “Yes” of step S902) and the switching condition of the second driving mode is satisfied (i.e., “Yes” of step S907), that is, in a case where mode switching from the first driving mode to the second driving mode is performed. In this case, the voltage modulation index MI at the time point of starting the mode switching corresponds to the voltage modulation index MI_b of the first driving mode in step S908, and the controller 40 subtracts a compensation value from the voltage modulation index MI in step S909 until the voltage modulation index MI increases and reaches the voltage modulation index MI_a of the second driving mode (i.e., “Yes” of step S910). When the voltage modulation index MI reaches the voltage modulation index MI_a of the second driving mode (i.e., “Yes” in step S910), the controller 40 determines the present voltage modulation index MI as the control value MI_Ref of the voltage modulation index in step S911, and then generates an electric current command on the basis thereon in step S912.

According to various exemplary embodiments of the present disclosure as described above, the driving distance of an electrified vehicle may be efficiently increased by utilizing the auxiliary battery together with the main battery to drive the motor.

In addition, through the linearization control of the voltage modulation index, it is possible to alleviate the torque fluctuations that may occur when the discharge of the auxiliary battery starts or stops.

As described above, although preferred embodiments of the present disclosure have been described for illustrated and described, it is apparent that those skilled in the art will appreciate that the embodiments of the present disclosure can be improved and changed in various ways without departing from the technical spirit of the present disclosure as provided and disclosed in the accompanying claims below.

What is claimed is:

1. An electrified vehicle capable of mounting an auxiliary battery, the electrified vehicle comprising:
a motor having a plurality of windings;
a first inverter having a plurality of direct current (DC) terminals and including a plurality of legs connected to first ends of each of the plurality of windings;
a main battery connected to the plurality of DC terminals; and
a controller configured to perform linearization control on a voltage modulation index while the auxiliary battery is mounted to limit a change rate of the voltage modulation index serving as a basis for an electric current command for the motor during switching between a first driving mode and a second driving mode;
wherein the first driving mode is configured to drive the motor in a state where the auxiliary battery and the motor are electrically disconnected from each other; and
wherein the second driving mode is configured to drive the motor in a state where the auxiliary battery is electrically connected between one end of the plurality of DC terminals and second ends of each of the plurality of windings.

2. The electrified vehicle of claim 1, wherein the controller is configured to perform the linearization control by adding or subtracting a preset correction value to or from the voltage modulation index according to the mode before the switching, during the switching between the first driving mode and the second driving mode.

3. The electrified vehicle of claim 2, wherein the preset correction value is set to have a value smaller than a difference between a maximum value of the voltage modulation index available in the first driving mode and a maximum value of the voltage modulation index available in the second driving mode.

4. The electrified vehicle of claim 2, wherein the controller is configured to repeat the adding or subtracting of the preset correction value until the voltage modulation index according to the mode before the switching reaches the voltage modulation index according to the mode after the switching.

5. The electrified vehicle of claim 2, wherein the controller is configured to determine a present voltage modulation index as a control value of the voltage modulation index, and to generate the electric current command based on the control value of the voltage modulation index in response to the voltage modulation index according to the mode before the switching reaches the voltage modulation index according to the mode after the switching.

6. The electrified vehicle of claim 2, wherein the controller is configured to perform the linearization control by performing the subtracting of the preset correction value during the switching from the first driving mode to the second driving mode.

7. The electrified vehicle of claim 2, wherein the controller is configured to perform the linearization control by performing the adding of the preset correction value during the switching from the second driving mode to the first driving mode.

8. The electrified vehicle of claim 1, further comprising:
a plurality of charging switches connected between the auxiliary battery and the second ends of each of the plurality of windings,
wherein the controller is configured to control the switching between the first driving mode and the second driving mode by turning on or off the plurality of charging switches.

9. The electrified vehicle of claim 1, further comprising:
a second inverter comprising a plurality of legs connected to the second ends of each of the plurality of windings,
wherein the first driving mode comprises:
a closed end winding (CEW) mode configured to drive the motor only with the first inverter; and
an open end winding (OEW) mode configured to drive the motor through the first inverter and the second inverter.

10. The electrified vehicle of claim 9, further comprising:
a plurality of switching switches each having a first end connected to the second ends of each of the plurality of windings, and each having second ends interconnected together to form a node,
wherein the controller is configured to control the first driving mode as the CEW mode or the OEW mode by turning on or off the plurality of switching switches.

11. A method of controlling an electrified vehicle comprising a motor having a plurality of windings, a first inverter having a plurality of direct current (DC) terminals and including a plurality of legs connected to first ends of each of the plurality of windings, and a main battery connected to the plurality of DC terminals, the electrified vehicle being capable of mounting an auxiliary battery, and the method comprising:
generating, by a controller, an electric current command for the motor based on a voltage modulation index; and
performing, by the controller, linearization control on the voltage modulation index while the auxiliary battery is mounted to limit a change rate of the voltage modulation index during switching between a first driving mode and a second driving mode;
wherein the first driving mode is configured to drive the motor in a state where the auxiliary battery and the motor are electrically disconnected from each other; and
wherein the second driving mode is configured to drive the motor in a state where the auxiliary battery is electrically connected between the plurality of DC terminals to which the main battery is connected and the plurality of windings.

12. The method of claim 11, wherein performing the linearization control comprises:
adding or subtracting a preset correction value to or from the voltage modulation index according to the mode before the switching, during the switching between the first driving mode and the second driving mode.

13. The method of claim 12, wherein the preset correction value is set to have a value smaller than a difference between a maximum value of the voltage modulation index available in the first driving mode and a maximum value of the voltage modulation index available in the second driving mode.

14. The method of claim 12, wherein the adding or subtracting of the preset correction value is repeated until the voltage modulation index according to the mode before the switching reaches the voltage modulation index according to the mode after the switching.

15. The method of claim 12, further comprising:
determining a present voltage modulation index as a control value of the voltage modulation index in response to the voltage modulation index according to the mode before the switching reaches the voltage modulation index according to the mode after the switching,
wherein the generating of the electric current command comprises:
generating the electric current command based on the control value of the voltage modulation index.

16. The method of claim 12, wherein performing the linearization control comprises:
performing the subtracting of the preset correction value during the switching from the first driving mode to the second driving mode.

17. The method of claim 12, wherein performing the linearization control comprises:
performing the adding of the preset correction value during the switching from the second driving mode to the first driving mode.

18. The method of claim 11, further comprising:
controlling the switching between the first driving mode and the second driving mode through turning on or off a plurality of charging switches connected between the auxiliary battery and the plurality of windings.

19. The method of claim 11, wherein the electrified vehicle further comprises:
a second inverter comprising a plurality of legs connected to second ends of each of the plurality of windings of the motor, and
wherein the first driving mode comprises:
a closed end winding (CEW) mode configured to drive the motor only with the first inverter; and
an open end winding (OEW) mode configured to drive the motor through the first inverter and the second inverter.

20. The method of claim 19, further comprising:
controlling the first driving mode as the CEW mode or the OEW mode through turning on or off of a plurality of switching switches having first ends each connected to the second ends of each of the plurality of windings, and each having second ends interconnected together to form a node.
